(19) United States
(12) Patent Application Publication
(10) Pub. No.: US 2006/0289251 A1
(43) Pub. Date: Dec. 28, 2006

(54) Taper wear compensation of a friction pad for a disc brake assembly

(75) Inventors: Antonio Eduardo DeMorais, South Lyon, MI (US); Harry Miller, Canton, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Kelsey-Hayes Company

(21) Appl. No.: 11/159,668

(22) Filed: Jun. 23, 2005

(51) Int. Cl. F16D 65/14

(52) U.S. Cl. 188/73.47; 188/73.46

(57) ABSTRACT

A disc brake caliper for braking a wheel if a vehicle includes an inboard wall, an outboard wall spaced laterally from the inboard wall, each wall having a leading hole spaced a first distance on a first side from a lateral axis and extending through the respective wall, a trailing hole spaced a second distance on a second side opposite the first side from the lateral axis and extending through the respective wall, and a bridge interconnecting the inboard wall and the outboard wall.

### BACKGROUND OF THE INVENTION

This invention relates in general to disc brake assemblies and in particular to an improved caliper for use in a disc brake assembly for a vehicle.

Most vehicles are equipped with a brake system for slowing or stopping movement of the vehicle in a controlled manner. A typical brake system for an automobile or light truck includes a disc brake assembly for each of the front wheels and either a drum brake assembly or a disc brake assembly for each of the rear wheels. The brake assemblies are actuated by hydraulic or pneumatic pressure generated when an operator of the vehicle depresses a brake pedal. The structures of these drum brake assemblies and disc brake assemblies, as well as the actuators therefor, are well known in the art.

A typical disc brake assembly includes a rotor, which is secured to the wheel of the vehicle for rotation therewith. A caliper assembly is supported on pins, which are secured to an anchor bracket. The anchor bracket is secured to a non-rotatable component of the vehicle, such as the vehicle frame. The caliper assembly includes a pair of brake shoes, located on opposite sides of the rotor. The brake shoes are operatively connected to one or more hydraulically actuated pistons for movement between a non-braking position, wherein they are spaced apart from opposed axial sides or braking surfaces of the rotor, and a braking position, wherein they are moved into frictional engagement with the braking surfaces of the rotor. When the operator of the vehicle depresses the brake pedal, the piston urges the brake shoes from the non-braking position to the braking position causing their frictional engagement with the opposed braking surfaces of the rotor, thereby slowing or stopping rotation of the associated wheel of the vehicle.

The service life of a brake pad is influenced by the uniformity of contact pressure between the friction plates of the rotor and friction surface of the brake pad when the brake is applied. If the pressure is unevenly distributed across the face of the friction pad, over the period of its use the friction pad will have a higher rate of wear over a local area and less wear elsewhere. Under such condition, the service life of the brake pad is shorter than if friction pad wear were uniform across its face. Loads applied to the brake pad by the actuating piston and rotor, the location of these loads, and the location of reaction forces to the applied loads can cause uneven wear and a reduced service life. Uneven brake pad pressure distribution can also cause brake noise.

There is a need to adjust the location of the reaction forces applied to the brake pads by the calipers to eliminate uneven brake pad wear. Preferably, a brake caliper that accomplished this desired result can be used on both the left-hand wheel and right-hand wheel, without requiring that the caliper be used on the wheels of only one vehicle side or at the front wheels or rear wheels.

### SUMMARY OF THE INVENTION

A disc brake caliper according to this invention is formed includes an inboard wall, an outboard wall spaced laterally from the inboard wall, and a bridge interconnecting the inboard wall and the outboard wall. Preferably the caliper in a blank condition is an aluminum casting.

Regarding the terms “leading” and “trailing” used in this description, when a brake rotor, such as the rotor 52 shown in FIG. 1, rotates while driving a vehicle wheel in the forward direction, a radius of the rotor first passes the “leading” side of the brake assembly before the rotor's radius passes the “trailing” side of the brake assembly.

Each inboard and outboard wall of the caliper blank is machined with a mutually-aligned leading pin hole that is spaced on the leading side a first distance from a lateral axis, and extends through the thickness of the walls. Similarly, each inboard and outboard wall of the casting is also formed with mutually-aligned trailing pin hole that is spaced on the trailing side a second distance from the axis, and extends through the thickness of the walls. The first distance, which may be less than, equal to, or greater than the second distance, is determined for a particular vehicle application by testing, such that wear of the friction pads, supported on the caliper at the leading and trailing pin holes, is uniform across the width of the pad.

The locations of the leading and trailing pin holes on the caliper are predetermined for each vehicle application. The caliper and a disc brake assembly that includes the caliper can be used on either side of the vehicle, provided that the caliper is machined for use on the left-hand or right-hand side of the vehicle. No dimension or feature of the caliper, brake pad assembly or any other component of the brake assembly, other than the machined caliper, is specific to the right-hand or left-hand side of the vehicle or to a front or rear location on the vehicle. Each actuating piston, or pair of actuating pistons, is supported on the caliper substantially aligned with the lateral axis of the caliper.

The caliper can be formed using a single die without regard to its installed location. The disc brake assembly can be prepared with brake shoes that are identical for each vehicle wheel location. The inboard shoe and outboard shoe are also the same. Preparation of the caliper assembly becomes easier since common components for left and right hand side are being used.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a portion of a prior art vehicle disc brake assembly;

FIG. 2 is an exploded perspective view of selected components of the prior art vehicle disc brake assembly illustrated in FIG. 1;

FIG. 3 is a sectional elevation view of a portion of the prior art disc brake assembly illustrated in FIG. 1;

FIG. 4 is a perspective view of a disc brake caliper located on a right-hand wheel and viewed from the inboard side, the wheel rotating in the forward direction;

FIG. 5 is an exploded perspective view, which illustrates the relative positions of the component of the caliper of FIG. 4;

FIG. 6 is a bottom view of the of the caliper of FIG. 4;

FIG. 7 is a side view from the inboard side of the caliper of FIG. 4;

FIG. 8 is a side view of a brake shoe that can be used with the caliper of FIG. 1;

FIG. 9 is a side view of an alternate brake shoe that can be used with the caliper of FIG. 1;

FIG. 10 is a schematic free body diagram showing a technique in the prior art for attaching and supporting brake shoes on a caliper;

FIG. 11 is a schematic free body diagram showing a technique according to the present invention for supporting each brake shoe on the caliper at the leading abutment pin; and

FIG. 12 is a schematic free body diagram showing a technique for supporting each brake shoe on the caliper at the leading and trailing abutment pin locations.

### DETAILED DESCRIPTION OF THE PREFERRED EMBODIMENTS

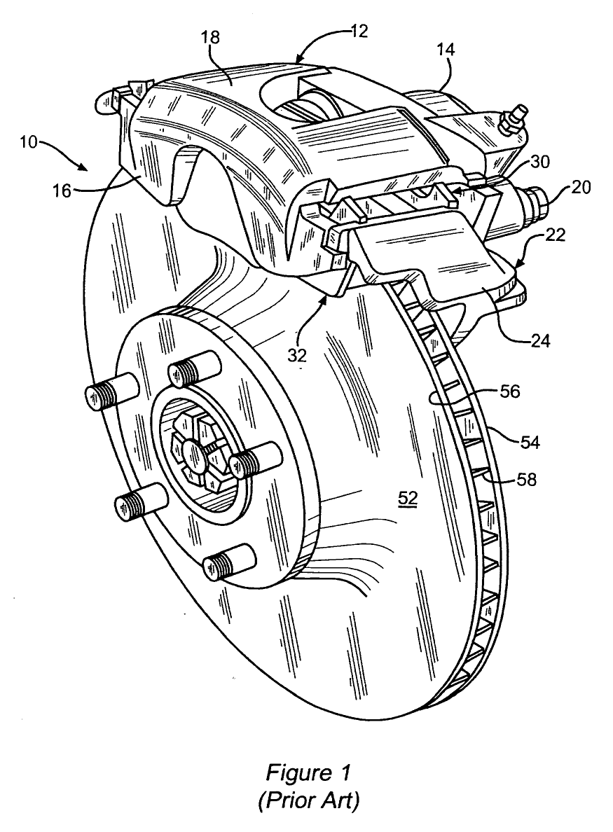

Referring now to the drawings, there is illustrated in FIGS. 1 through 3 a portion of a prior art vehicle disc brake assembly, indicated generally at 10. The general structure and operation of the prior art disc brake assembly 10 is conventional in the art. Thus, only those portions of the prior art disc brake assembly 10 that are necessary for a full understanding of this invention will be explained and illustrated. Although this invention will be described and illustrated in connection with the particular kind of vehicle disc brake assembly 10 disclosed herein, it will be appreciated that this invention may be used in connection with other kinds of disc brake assemblies if so desired.

As shown in prior art FIG. 1, the disc brake assembly 10 is a sliding type of disc brake assembly and includes a generally C-shaped caliper, indicated generally at 12. The caliper 12 includes an inboard wall portion 14 and an outboard wall portion 16, which are interconnected by an intermediate bridge portion 18. The caliper 12 is slidably supported on a pair of pins 20 secured to an anchor bracket, indicated generally at 22. The anchor bracket 22 is, in turn, secured to a stationary component of the vehicle, for example, an axle flange (not shown), when the disc brake assembly 10 is installed at a rear wheel; or a steering knuckle (not shown), when the disc brake assembly 10 is installed at a front wheel.

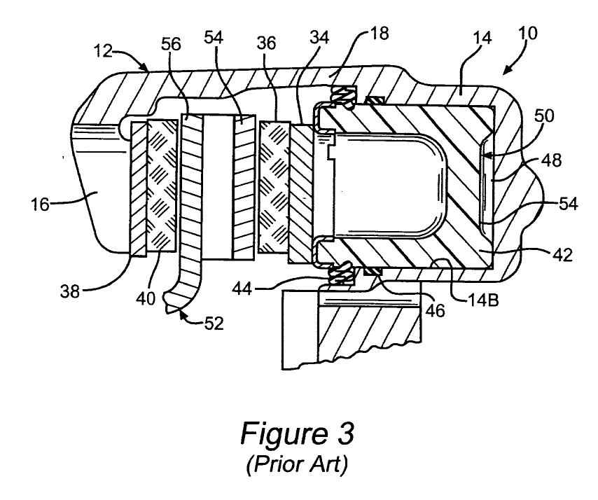

The pins 20 extend through non-threaded apertures 14A formed in the inboard wall 14 of the caliper 12. Each pin 20 has a threaded end 20A, which is received in a threaded aperture 22A provided in anchor bracket 22. The pins 20 support the caliper 12 for sliding movement relative to the anchor bracket 22 in both the outboard direction (leftward when viewing FIG. 3) and the inboard direction (rightward when viewing FIG. 3). Such sliding movement of the caliper 12 occurs when the disc brake assembly 10 is actuated, as will be explained below. A pair of bolts (not shown) extends through a pair of non-threaded apertures 22B formed in the anchor bracket 22 to secure the anchor bracket 22 to the stationary vehicle component. Alternatively, other known securing methods can be used to secure the anchor bracket 22 to the stationary vehicle component.

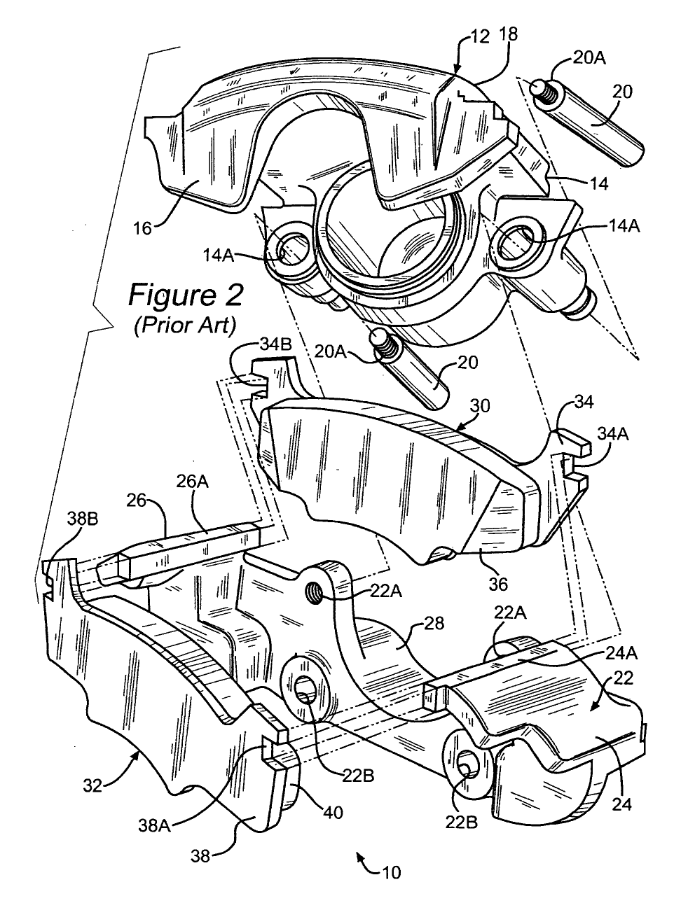

As best shown in FIG. 2, the anchor bracket 22 includes a pair of axially and outwardly extending arms 24 and 26, which are interconnected at their inboard ends by an inner tie bar 28. The arms 24 and 26 have upstanding guide rails 24A and 26A respectively formed thereon. The guide rails 24A and 26A extend transverse to the arms 24 and 26, respectively, and parallel to one another. The guide rails 24A and 26A support an inboard brake shoe 30 and an outboard brake shoe 32, respectively, which slide on the guide rails.

The inboard brake shoe 30 includes a backing plate 34 and a friction pad 36. The inboard backing plate 34 includes opposed ends having notches 34A and 34B formed therein, which engage the guide rails 24A and 26A of the anchor bracket 22 and support the inboard brake shoe 30 thereon. The outboard brake shoe 32 includes a backing plate 38 and a friction pad 40. The outboard backing plate 38 includes opposed ends having notches 38A and 38B formed therein, which engage the guide rails 24A and 26A of the anchor bracket 22 and support the outboard brake shoe 32 thereon. Alternatively, the inboard brake shoe 30 can be supported on a brake piston of the prior art disc brake assembly 10, while the outboard brake shoe 32 can be supported on the outboard wall portion 16 of the caliper 12.

An actuation means, indicated generally at 50 in FIG. 3, is provided for effecting the operation of the disc brake assembly 10. The actuation means 50 includes a brake piston 42, which is disposed in a cylinder or recess 14B, bored in the outboard surface of the inboard wall 14 of the caliper 12. The actuation means 50, shown in this embodiment as being a hydraulic actuation means, operates to move the piston 42 within the cylinder 14B in the outboard direction (leftward when viewing FIG. 3). However, other types of actuation means 50, such as electrical, pneumatic, and mechanical types, can be used.

The prior art disc brake assembly 10 also includes a dust boot seal 44 and an annular fluid seal 46. The dust boot seal 44 is formed from a flexible material and has a first end, which engages an outboard end of the cylinder 14B. A second end of the dust boot seal 44 engages an annular groove formed in an outer side wall of the piston 42. A plurality of flexible convolutions is provided in the dust boot seal 44 between the first and second ends thereof. The dust boot seal 44 is provided to prevent water, dirt, and other contaminants from entering into the recess 14B. The fluid seal 46 is disposed in an annular groove formed in a side wall of the recess 14B and engages the radial outer surface of the piston 42. The fluid seal 46 is provided to define a sealed hydraulic actuator chamber 48, within which the piston 42 is disposed for sliding movement. Also, the fluid seal 46 is designed to function as a “roll back” seal to retract the piston 42 within the recess 14B (rightward when viewing FIG. 3) when the brake pedal is released.

The prior art disc brake assembly 10 further includes a brake rotor 52, which is secured to a wheel (not shown) of the vehicle for rotation therewith. The illustrated brake rotor 52 includes a pair of opposed friction discs 54 and 56, which are spaced apart from one another by a plurality of intermediate fins or posts 58 in a known manner. The brake rotor 52 extends radially outward between the inboard friction pad 36 and the outboard friction pad 40.

When it is desired to actuate the prior art disc brake assembly 10 to retard or stop rotation of the brake rotor 52 and the vehicle wheel secure to the rotor, the driver of the vehicle depresses the brake pedal (not shown). In a manner that is well known in the art, depression of the brake pedal causes pressurized hydraulic fluid to be introduced into the cylinder 48. The pressurized hydraulic fluid urges the piston 42 in the outboard direction (toward the left when viewing art FIG. 3) into engagement with the backing plate 34 of the inboard brake shoe 30. As a result, the friction pad 36 of the inboard brake shoe 30 is moved into frictional engagement with the inboard friction disc 54 of the brake rotor 52. At the same time, the caliper 12 slides on the pins 20 in the inboard direction (toward the right when viewing art FIG. 3) such that its outboard wall 16 moves the friction pad 40 of the outboard brake shoe 32 into frictional engagement with the outboard friction disc 56 of the brake rotor 52. As a result, the opposed friction discs 54 and 56 of the brake rotor 52 are frictionally engaged by the respective friction pads 36 and 40 to slow or stop rotation of the brake rotor 52 and wheel. The structure and operation of the prior art disc brake assembly 10 thus far described is conventional in the art.

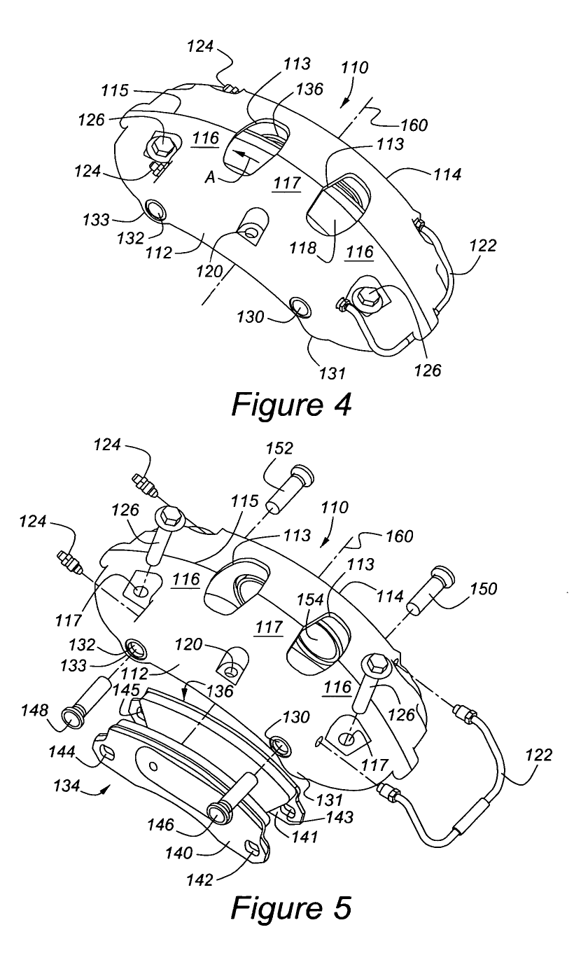

Referring now to FIGS. 4-7, the present invention is described with reference to a disc brake assembly 110 that includes an actuating piston in a brake cylinder located in an inboard caliper wall and another piston in a brake cylinder located in an outboard caliper wall. A brake disc assembly of this type is called a fixed caliper-opposed piston design. The present invention is applicable also to a sliding caliper disc brake assembly, such as that described with reference to FIGS. 1-3, and to the fixed caliper opposed piston disc brake assembly, described with reference to FIGS. 4-7.

The disc brake caliper 110 illustrated in FIGS. 4-7 is a unitary component formed with an inboard wall 112, outboard wall 114, and a bridge 116 interconnecting the inboard and outboard walls at a radial outer surface and having a window 113 on opposite side of a transverse axis 160, through which windows an outer brake shoe and a friction disc 118 can be seen in FIG. 4. The caliper blank, prior to machining, is symmetric about longitudinal plane 115 and about plane 160. The inboard wall 112 is formed with a laterally-directed cylinder containing a first piston when installed, and the outer wall 114 is formed with a similar cylinder containing an opposed second cylinder when installed. Each piston forces a brake shoe into contact with the friction disc 118 from an opposite lateral side of the rotor. Arrow A indicates the direction of rotation of the friction disc 118 and vehicle wheel when the wheel rotates to propel the vehicle in the forward direction.

The bridge 116 that interconnects the inboard and outboard walls 112, 114 includes a beam portion 117 located between the windows 113. The presence of the beam strengthens and stiffens the bridge, thereby allowing the wall thickness of the bridge 116 to be relatively thin and permitting use of a rotor 118 having a larger diameter for a given wheel size.

Pressurized hydraulic brake fluid is both supplied to the caliper and returned to a master cylinder through an inlet 120 formed in the inboard caliper wall 112 by machining the caliper after it is formed by casting. A crossover tube 122 hydraulically connects the inner hydraulic brake cylinder and the outer hydraulic brake cylinder.

The caliper 110 is fitted with two bleed screws 124, through which air can be removed from the hydraulic system. Two hex head bolts 126, seated in recesses formed on the outer surface of the caliper 110, mechanically secure the caliper to a steering knuckle or axle flange.

After the caliper blank is cast or formed by another method, the inboard wall 112 and outboard wall 114 of caliper 110 are machined with leading holes 130 and trailing holes 132, each hole extending through the respective wall and receiving an abutment pin upon assembly. The leading holes 130 are mutually axially aligned; the trailing holes 132 are mutually axially aligned. The trailing hole 132, shown in FIG. 4, is located at a lug 133 that is formed in the wall 112; the leading hole 130 is shown spaced from a lug 131 that is formed in the wall 112. The location of the holes 130, 132, however, may be reversed such that the trailing holes 132 are located at lugs 131, and the leading holes 130 are spaced from lugs 133. Or neither hole 130, 132 may be located at a lug, or both holes may be located at a lug, depending on the preferred location as discussed below. In any case, the preferred location of the leading holes 130 and trailing holes 132 is preferably determined or demonstrated empirically for a particular vehicle application, and then the holes are machined in the casting at the desired location for the application.

FIG. 5 is an exploded assembly view, which illustrates the relative positions of the inboard brake shoe 134 and outboard brake shoe 136 when assembled in the caliper. Each brake shoe 134, 136 includes a friction pad 138 secured to the inboard surface of a backing plate 140, 141, which is formed with an elongated leading hole 142-143 and an elongated trailing hole 144, 145. Upon assembly, a leading abutment pin 146 is fitted in the leading abutment pin hole 130, and a trailing abutment pin 148 is fitted in the trailing abutment pin hole 132. Similarly, on the outboard side of caliper 110, the leading abutment pin 150 and the trailing abutment pin 152 are each fitted into a respective hole formed in the outboard wall 114 of the caliper 110.

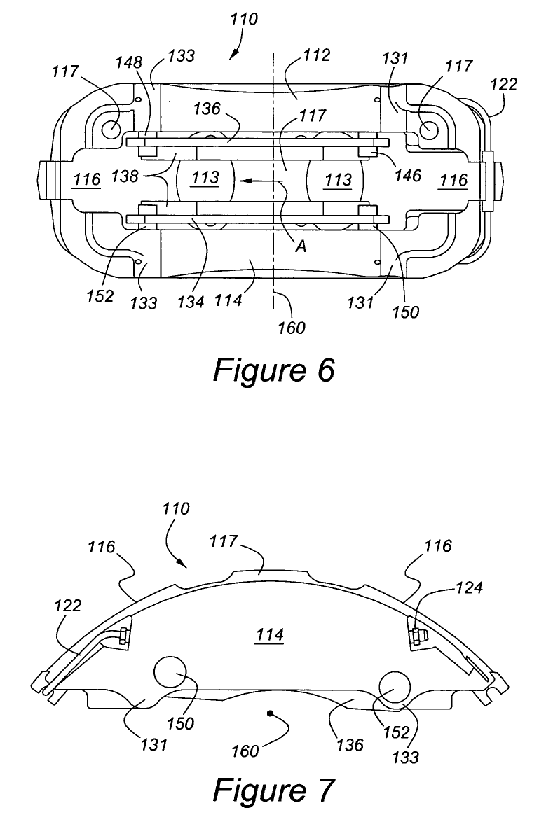

As shown in FIG. 6, the piston 154, which actuates the outboard brake shoe 136 to move inboard into engagement with the rotor disc 118, is located in a cylinder formed in the outboard caliper wall 114. Similarly, the inboard piston that actuates the inboard brake shoe 134 to move outboard into engagement with rotor disc 18 is located in the inboard caliper wall 112.

FIGS. 6 and 7 show the leading abutment pins 146, 150 located closer to the transverse axis 160 and the trailing abutment 148, 152 located more distance from axis 160 than the leading abutment pins. The head of each trailing abutment pin 148, 152 is located within the contour of lug 133, but the head of each leading abutment pin 146, 150 is located away from the lug 131 at the leading side of the caliper 110.

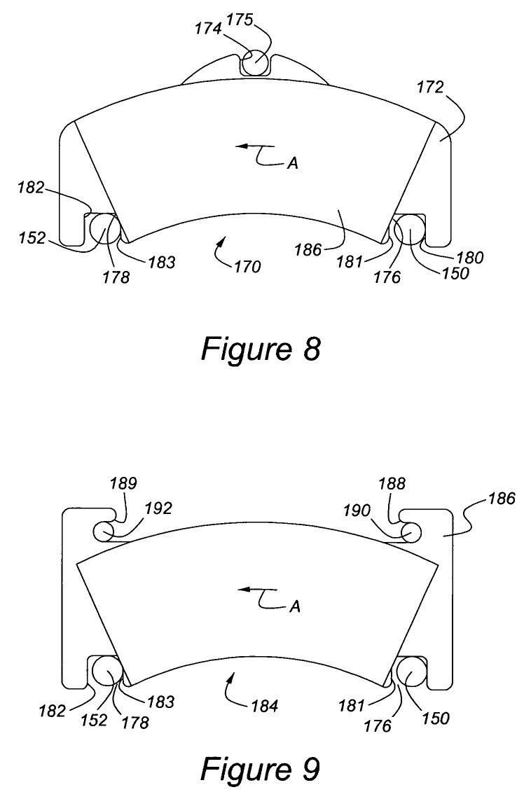

FIG. 8 is a front view of an alternate brake shoe 170 for use with the caliper. The backing plate 172 of brake shoe 170 is formed with a recess 174, into which is fitted a pin 175 that extends transversely across the caliper parallel to axis 160 and is seated on the base of the recess 174 to hold the brake shoe in position against movement in the outward radial direction. Backing plate 172 is formed with a leading recess 176, into which is fitted the leading abutment pin 150, and a trailing recess 178, into which is fitted the trailing abutment pin 152. When the vehicle moves forward, the rotor 118 rotates in direction A; therefore, when brake shoe 170 engages the rotor, the brake shoe is displaced in direction A, such that the leading abutment pin 150 contacts the leading surface edge 180 of the recess 176 and is spaced from the edge surface 181 of recess 176. The trailing abutment pin 152 may be spaced from the leading and trailing edge surfaces 182, 183 of trailing recess 178, or pin 152 may contact the surface 183. As brake shoe 170 moves axially along the surface of pin 150 while the friction pad 186 engages the rotor 118, a friction force is developed on the leading edge surface 180 of recess 176.

FIG. 9 illustrates another brake shoe 184. The backing plate 186 of brake shoe 184 is formed with two hooks 188, 189, engaged respectively by pins 190, 192, which extend transversely across the caliper 110 parallel to lateral axis 160 to hold the brake shoe in position and prevent radial movement from the position shown in FIG. 9. Backing plate 186 is formed with a leading recess 176, into which is fitted the leading abutment pin 150, and a trailing recess 178, into which is fitted the trailing abutment pin 152. The forward direction of the rotor is direction A. When brake shoe 184 engages the rotor 118, the brake shoe is displaced in direction A, such that the leading abutment pin 150 contacts the leading edge surface edge 180 of the recess 176 and is spaced from the edge surface 181 of recess 176. The trailing abutment pin 152 may be spaced from the leading and trailing edge surfaces 182, 183 of recess 178, or it may contact the leading surface 183 of recess 178. As brake shoe 184 moves axially along the surface of pin 150 while the friction pad 186 engages the rotor 118, a friction force is developed on the leading edge surface 180 of recess 176.

The location of the leading and trailing holes 130, 132 for the leading abutment pins 146, 150 and trailing abutment pins 148, 152 determines whether the pins contact the edge surfaces 180-183 of the recesses 176, 178 or the surfaces of backing plate holes 142-144 of brake shoes 134, 136 that correspond to surfaces 180-183.

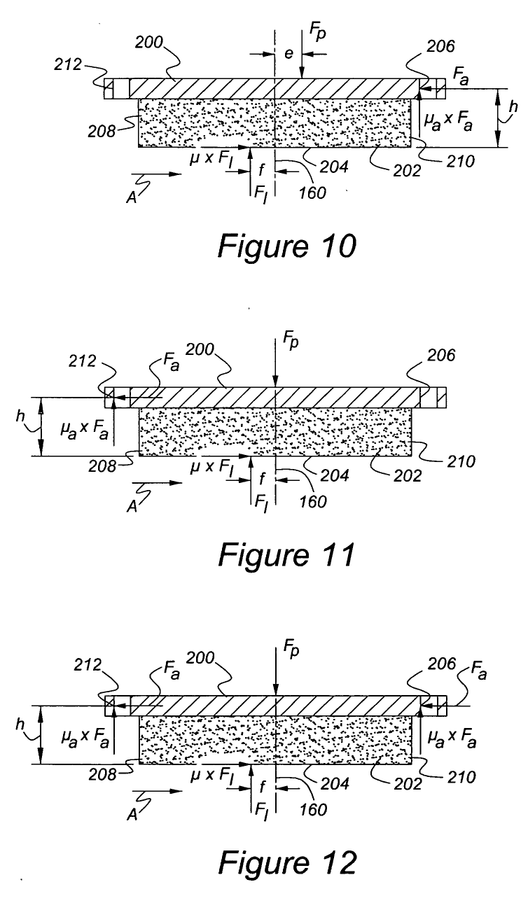

FIG. 10 is a free body diagram of a disc brake shoe fitted in a brake caliper, the diagram showing the applied loads and reaction forces on the brake shoe when supported on the caliper using a conventional technique. The brake shoe includes a backing plate 200 and a friction pad 202, secured to the backing plate and facing a brake disc which passes in direction A, from left to right, across the inboard face 204 of the friction pad when the wheel turns in the forward drive direction. A force Fₚ applied by the brake piston to the backing plate moves the friction pad 202 into engagement with the brake disc. The applied force Fₚ is offset by distance (e) from the transverse axis 160 of the brake assembly.

The resultant of pressure on the area of contact between the friction pad 202 and brake disc is F₁, which is offset by distance (f) from the transverse axis 160 due to non-uniformity of the contact pressure across the inboard face 204 of the friction pad. The contact pressure force F₁ has a friction force component μ×F₁ that is applied to the inboard surface 204 of friction pad 202 due to movement of the brake rotor on that surface. The coefficient of friction on the interface surface between the brake disc and friction pad 202 is μ.

The friction force μ×F₁ is reacted by force Fₐ at the surface of contact between the trailing abutment pin contact 206 and the backing plate 200, which is offset by the distance (h) from the inboard surface 204 of the brake shoe. The reaction force Fₐ has a friction force component μₐ×Fₐ that is developed on the backing plate at the abutment pin hole due to movement of the backing plate on the trailing abutment pin surface. The coefficient of friction between the abutment pin and the abutment pin hole is μₐ. The distance h is equal to the thickness of the friction pad plus one-half the backing plate thickness.

The couple produced by the abutment pin reaction force Fₐ and the friction force μ×F₁ tends to rotate the brake pad in a counterclockwise direction when viewed as in FIG. 10. In addition, μₐ×Fₐ is directed opposite from Fₚ and this increases the magnitude of the rotation. The overturning moment is increased further at the trailing end by μₐ×Fₐ which can couple with μ×F₁. This counterclockwise rotation increases the magnitude of contact pressure between the rotor disc and brake pad surface 204 in the vicinity of the leading edge 208 and decreases the magnitude of contact pressure between the rotor disc and brake pad surface in the vicinity of the trailing edge 210. This non-uniformity of contact pressure causes greater wear of the friction pad 202 at the leading edge 208 and less wear at the training edge 210. To overcome this uneven wear of the friction pad and to counter the eccentricity of the contact pressure force F₁ from the lateral axis 160, it is conventional to offset the centerline of the brake piston and piston force Fₚ by distance (e) on the trailing side of the lateral axis 160.

FIG. 11 is a free body diagram of a friction brake shoe supported on the brake caliper in accordance with the present invention. The force Fₐ that reacts the friction force μ×F₁ is located at the leading abutment pin contact 212, and the hydraulically actuated piston force Fₚ is substantially aligned with the lateral axis 160. The leading abutment pin contact 212 is located closer to the lateral axis 160 than is the trailing abutment pin contact 206, which in this arrangement does not contact the backing plate 200 and provides no reaction to the applied loads.

In the arrangement of FIG. 11, the couple comprising the leading abutment pin reaction force Fₐ and the friction force μ×F₁ on the inboard surface 204 of the friction pad 202 again produces a counterclockwise moment tending to increase the contact pressure on surface 204 near the leading edge 208 of the friction pad 202 and to decrease the contact pressure on surface 204 at the trailing edge 206 of the friction pad. This overturning moment is partially reacted by the frictional component force μₐ×Fₐ on the abutment pin contact at 212. Therefore, the distribution of the contact pressure on the friction face 204 of the friction pad 202 can be adjusted by changing the location of the leading and trailing abutment pin contacts 212 and 206, respectively, relative to the lateral axis 160, and, when optimized, the contact pressure can be made uniform. In the example of FIG. 11, the distance between the leading abutment pin contact 212 and the lateral axis 160 is less than the distance between the trailing abutment pin contact 206 and axis 60. FIGS. 4-7 illustrate the caliper with this configuration. The optimal location of the leading abutment pin that produces the most uniform wear of the friction pad surface 204 is determined empirically for each vehicle application, and the abutment pin holes 130, 132 are machined at the optimum location. Because the brake piston is substantially aligned with lateral axis 160, the machined caliper can be used at any wheel of the vehicle without alteration, except for closing an unused fluid supply port 120, as described below.

Alternatively, both the leading abutment pins 146, 150 and trailing abutment pins 148, 152 may located such that they both provide a reaction to the friction force μ×F₁ that is located on surface 204. FIG. 12 illustrates the leading and trailing abutment pin contacts 212, 216 providing a reaction on the backing plate 200 to the friction force μ×F₁. In this instance, again the optimal location of the leading and trailing abutment pins that produce the most uniform wear of the friction pad surface 204 is determined empirically for each vehicle application, and the abutment pin holes 130, 132 are machined at the optimum locations. The brake piston is aligned with lateral axis 160, and the machined caliper can be used at any wheel of the vehicle.

The optimal location of the leading and trailing abutment pins that will produce uniform brake pad wear is determined empirically because the forces affecting brake pad wear depend on the magnitude of force F₁. The magnitude of force F₁ can vary from application to application and among different duty cycles even when the brake assembly has the same piston size. Therefore, due to the number and range of variables involved, it is preferable to determine by testing the optimal location of the leading and trailing abutment pin contacts 212 and 206.

After a caliper blank is formed, preferably by casting or another method, it is machined appropriately to form a hydraulic brake fluid inlet port 120, recesses and holes for the two bolts 126 on the outer surface of the inboard wall 112 for securing the caliper to the vehicle, two holes for the bleed screws 124 through which air can be removed from the hydraulic system, holes that receive the crossover tube 122 that hydraulically connects the inboard and outboard hydraulic brake cylinders, and abutment pin holes 130, 132 in the inboard and outboard walls 112, 114.

The caliper 110, when machined as shown in FIG. 4 but without the abutment pin holes, can be used on the left-hand or right-hand side of the vehicle, by rotating the caliper one-half revolution about a vertical axis that passes through plane 115 before installing the caliper on the vehicle; provided, the location of the leading abutment pin holes 130 with respect to lateral axis 160 is the same on both sides of the vehicle, and the location of the trailing abutment pin holes 132 with respect to lateral axis 160 is the same on both sides of the vehicle.

Alternatively, a caliper blank can be machined such that one inlet port 120 is formed symmetrically on each side of the longitudinal plane 115, i.e., on the inboard wall and outboard wall, and two recesses and two holes for the bolts 126 that secure the caliper to the vehicle are formed symmetrically on each side of plane 115, on the inboard wall and outboard wall. In FIG. 4, only one inlet port 120, and two recesses and two holes for the bolts 126 are shown located on the inboard wall. The inlet hole 120 on one side of plane 115 is closed by a plug, thereby defining the outboard wall of the caliper 110. The location of the leading abutment pin holes 130 with respect to lateral axis 160 is the same on both sides of the vehicle, and the location of the trailing abutment pin holes 132 with respect to lateral axis 160 is the same on both sides of the vehicle.

Alternative, the caliper blank can be machined such the machined caliper can be installed on either the right-hand or left-hand side of the vehicle. In this case, the hand or vehicle side on which the machined caliper is to be installed is predetermined, and the caliper is machined as shown in FIG. 4, i.e., with the inlet port 120, and recesses and holes for bolts 126 located on the inboard wall 112. The location of the leading abutment pin holes 130 with respect to lateral axis 160 is the same on both sides of the vehicle, and the location of the trailing abutment pin holes 132 with respect to lateral axis 160 is the same on both sides of the vehicle.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. A disc brake caliper for a brake assembly comprising:
an inboard wall;
an outboard wall spaced laterally from the inboard wall, each wall having leading hole spaced a first distance on a first side from a lateral axis and extending through a thickness of the respective wall, and a trailing hole spaced a second distance on a second side opposite the first side from the lateral axis and extending through a thickness of the respective wall, the caliper being suited for use on either the left side or right side of the vehicle; and
a bridge interconnecting the inboard wall and the outboard wall.

2. The disc brake caliper of claim 1 wherein the leading hole of the inboard wall is substantially aligned axially with the leading hole of the outboard wall, and the trailing hole of the inboard wall is substantially aligned axially with the trailing hole of the outboard wall.

3. The disc brake caliper of claim 1 wherein the first distance is greater than the second distance.

4. The disc brake caliper of claim 1 wherein the second distance is greater than the first distance.

5. The disc brake caliper of claim 1 wherein the second distance is substantially equal to the first distance.

6. The disc brake caliper of claim 1, further comprising:
multiple abutment pins, one abutment pin located in each hole and extending through the thickness of the respective wall.

7. The disc brake caliper of claim 1, further comprising:
a first brake shoe including a first backing plate having a first aperture aligned with the leading hole of the inboard wall, and a second aperture aligned with the trailing hole of the inboard wall;
a second brake shoe including a second backing plate having a first aperture aligned with the leading hole of the outboard wall, and a second aperture aligned with trailing hole of the outboard wall; and
multiple pins, one pin located in each hole and extending through the aperture that is aligned with a respective hole.

8. The disc brake caliper of claim 1, wherein the bridge has two longitudinally spaced windows, and the bridge further comprises a beam portion interconnecting the inboard wall and the outboard wall and located between the windows.

9. A disc brake assembly for braking a friction disc secured to a vehicle wheel comprising:
a brake caliper including an inboard wall, an outboard wall spaced laterally from the inboard wall, and a bridge interconnecting the inboard wall and the outboard wall, each wall having a leading pin hole spaced a first distance on a first side from a lateral axis and extending through a thickness of the respective wall, and a trailing pin hole spaced a second distance on a second side opposite the first side from the lateral axis and extending through a thickness of the respective wall, the caliper being suited for use on either the left side or right side of the vehicle;
leading abutment pins, one leading abutment pin located in each leading in hole;
trailing abutment pins, one trailing abutment pin located in each trailing in hole;
a first brake shoe including a first backing plate having a first aperture for receiving therein and contacting the leading abutment pin of the inboard wall, and a second aperture into which the trailing abutment pin of the inboard wall extends, and a first friction pad secured to the first backing plate and facing an inner surface of the outboard wall; and
a second brake shoe including a second backing plate having a first aperture for receiving therein and contacting the leading abutment pin of the outboard wall, and a second aperture into which the trailing abutment pin of the outboard wall extends, and a second friction pad secured to the second backing plate and facing an inner surface of the inboard wall and spaced laterally from the first friction pad.

10. The disc brake assembly of claim 9 wherein the leading pin hole of the inboard wall is substantially aligned axially with the leading pin hole of the outboard wall, and the trailing pin hole of the inboard wall is substantially aligned axially with the trailing pin hole of the outboard wall.

11. The disc brake assembly of claim 9 wherein the first distance is greater than the second distance.

12. The disc brake assembly of claim 9 wherein the second distance is greater than the first distance.

13. The disc brake assembly of claim 9 wherein the second distance is substantially equal to the first distance.

14. The disc brake assembly of claim 9, wherein
the second aperture of the first brake shoe receives therein and contacts he trailing abutment pin of the inboard wall; and
the second aperture of the second brake shoe receives therein and contacts the trailing abutment pin of the outboard wall.

15. The disc brake assembly of claim 9, further comprising:
an inboard piston supported on the inboard wall, substantially aligned with the lateral axis; and
an outboard piston supported on the inboard wall, substantially aligned with the lateral axis; and

16. A method for forming a disc brake caliper comprising the steps of:
(a) forming a caliper that includes an inboard wall, an outboard wall spaced laterally from the inboard wall, and a bridge interconnecting the inboard wall and the outboard wall;
(b) forming a first leading pin hole spaced a first distance on a first side from a lateral axis through a thickness of one of the inboard wall and outboard wall;
(c) forming a first trailing pin hole spaced a second distance on a second side opposite the first side from the lateral axis through said one of the inboard wall and outboard wall;
(d) forming through a thickness of the other wall of said one of the inboard wall and outboard wall a second leading pin hole substantially axially aligned with the first leading pin; and
(e) forming through a thickness of the other wall of said one of the inboard wall and outboard wall a second trailing pin hole substantially axially aligned with the first trailing pin hole.

17. A method of claim 16 wherein step (a) further comprises forming the caliper as an aluminum casting.

18. The method of claim 16 wherein:
step (a) further comprises machining the first leading pin hole;
step (b) further comprises machining the first trailing pin hole;
step (c) further comprises machining the second leading pin hole; and
step (d) further comprises machining the second trailing pin hole.

19. The method of claim 16 wherein the first distance is one of greater than the second distance, less than the second distance, and substantially equal to the second distance.

20. The method of claim 16 further comprising:
installing in the caliper leading abutment pins, one leading abutment pin located in each leading pin hole;
trailing abutment pins, one trailing abutment pin located in each trailing pin hole;
installing in the caliper a first brake shoe including a first backing plate having a first aperture for receiving therein and contacting the leading abutment pin of the inboard wall, and a second aperture into which the trailing abutment pin of the inboard wall extends, and a first friction pad secured to the first backing plate and facing an inner surface of the outboard wall; and
installing in the caliper a second brake shoe including a second backing plate having a first aperture for receiving therein and contacting the leading abutment pin of the outboard wall, and a second aperture into which the trailing abutment pin of the outboard wall extends, and a second friction pad secured to the second backing plate and facing an inner surface of the inboard wall and spaced laterally from the first friction pad.

21. The method of claim 16 further comprising the step of removing the first and second brake shoes from the caliper through an opening located in the bottom of the caliper.

22. The method of claim 16 wherein step (a) further comprises:
forming on the outer surface of one of the inboard wall and the outboard wall first and second pairs of recesses and holes, each pair for receiving a bolt that secures the caliper to a vehicle; and
forming an inlet port on the outer surface of said one of the inboard wall and outboard wall.

23. The method of claim 16 wherein step (a) further comprises:
forming on the outer surface of the inboard wall and the outboard wall first and second pairs of recesses and holes, each pair for receiving a bolt that secures the caliper to a vehicle;
forming on the outer surface of the inboard wall and the outboard wall first and second inlet ports; and
mechanically closing one of said inlet ports.

24. The method of claim 16 wherein step (a) further comprises:
forming on the outer surface of the inboard wall first and second pairs of recesses and holes, each pair for receiving a bolt that secures the caliper to a vehicle; and
forming on the outer surface of the inboard wall first and second inlet ports.
